(19) United States
(12) Patent Application Publication
(10) Pub. No.: US 2003/0103324 A1
(43) Pub. Date: Jun. 5, 2003

(54) Position adjustable display screen for portable computer devices

(76) Inventor: Susanne M. Gallivan, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/998,655

(22) Filed: Dec. 3, 2001

(51) Int. Cl. G06F 1/16

(52) U.S. Cl. 361/681

(57) ABSTRACT

Display screen position adjusting mechanisms are provided for use in portable computers and other like devices. Certain mechanisms allow for the height of the display screen to be slidably adjusted with respect to the base unit of the device. Further mechanisms are provided that allow for the angle of display screen to be further adjusted with respect to the plane of the base unit. Such height and angular adjusting mechanisms may also allow for the display screen to be rotated, thereby changing the orientation of the display screen. These various mechanisms can be employed to improve the user ergonomics of the portable device.

### TECHNICAL FIELD

The present invention relates generally to portable computers and like devices, and more particularly to apparatuses for adjusting the position of the display screen of the portable computing device.

### BACKGROUND

Conventional portable computers, such as, for example, notebook or laptop computers, usually consist of a bi-folding two-part configuration having a base unit and a display unit. The base unit typically includes a keyboard and a touchpad or like pointing input device. The display unit includes a display screen, such as, for example, a liquid crystal display (LCD), an active matrix thin-film transistor (TFT) display, etc.

An exemplary conventional portable computer 100 is depicted in FIG. 1. Here, portable computer 100 is a notebook computer. When in use, the base unit 102 would typically rest on a desk or table, or on top of the user legs when seated. This way the user is able to reach the keyboard 104 with their hands. Portable computer 100 is opened/closed by folding up/down a display unit 106, which is connected to base unit 102 by a pivoting mechanism 108, e.g. a hinge, etc. When opened, the user can adjust the angle 110 of display unit 106, as needed, to provide a clear view of screen 112.

One drawback to this type of configuration is that the distance 114 between the plane of base unit 102 and the center of screen 112 is usually not sufficient to allow for proper ergonomic positioning of both the user's arms and head. For example, preferably, the user should have their upper arms about parallel to their torso and their elbows bent at about a ninety-degree angle such that their lower arms are about perpendicular to their torso. In reaching keyboard 104, the user's wrists should not be bent too much either. The user's neck and back should not be bent too much, nor should the user be required to strain their eyes downward to view screen 112.

Unfortunately, the distance 114 provided by a typical bi-folding portable computer does not provide the required separation for both the arms and head to be properly positioned. Thus, after some time, the user may become fatigued from not being able to better ergonomically position portable computer 100.

Consequently, there is a need for improved mechanisms that allow the parts of a portable computer or like device to be selectively positioned in a manner that is more ergonomic with respect to the user's body.

### SUMMARY

Improved mechanisms are provided that allow the parts of a portable computer or like device to be selectively positioned in a manner that is more ergonomic with respect to the user's body.

In accordance with certain exemplary implementations of the present invention, a portable computing device is provided in which the positioning of the display screen can be adjusted to provide for improved user ergonomics. The portable computing device includes a base unit and a display unit that is pivotally coupled to the base unit and having a height adjustable screen. The display unit can include a support unit that is pivotally coupled to the base unit, for example, and a position adjusting mechanism that couples the height adjustable screen with the support unit. In this manner, the position adjusting mechanism can be configured to allow the height adjustable screen to be positioned at least two different height distances from the base unit. In certain implementations, the position adjusting mechanism is configured to allow the height adjustable screen to be manually moved with respect to the support unit between the two different height distances. In other implementations, the position adjusting mechanism is configured to allow the height adjustable screen to be electrically moved with respect to the support unit between the two different height distances. By way of further example, the position adjusting mechanism can be configured to allow the height adjustable screen to be slidably moved with respect to the support unit so as to establish the two different height distances.

### BRIEF DESCRIPTION OF THE DRAWINGS

A more complete understanding of the various methods and arrangements of the present invention may be had by reference to the following detailed description when taken in conjunction with the accompanying drawings wherein:

FIG. 1 depicts a conventional bi-folding portable computer.

FIG. 2 depicts an exemplary bi-folding portable computer having a screen that can be height adjusted using a height adjusting mechanism, in accordance with certain implementations of the present invention.

FIG. 3A-F depict various exemplary configurations that allow a screen to be height adjusted using a height adjusting mechanism, in accordance with certain further implementations of the present invention.

FIG. 4 depicts an exemplary bi-folding portable computer having a screen that can be height adjusted using a multi-pivoting mechanism, in accordance with certain other implementations of the present invention.

FIG. 5 depicts an exemplary bi-folding portable computer having a screen that can be height adjusted and pivotally/rotationally adjusted, in accordance with still other implementations of the present invention.

FIG. 6 is a block diagram depicting exemplary techniques for operatively coupling a height adjustable and/or pivotally/rotationally adjustable screen to a base unit, in accordance with certain implementations of the present invention.

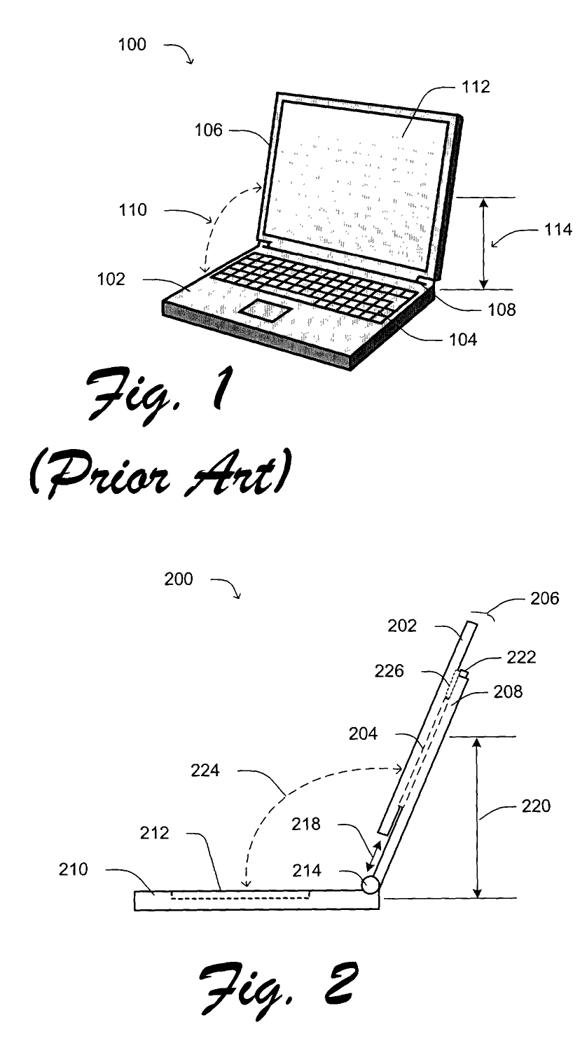

### DETAILED DESCRIPTION

Although the following exemplary implementations illustrate certain aspects of the present invention as embodied in various portable computers, the present invention is clearly adaptable to other portable computing and like devices.

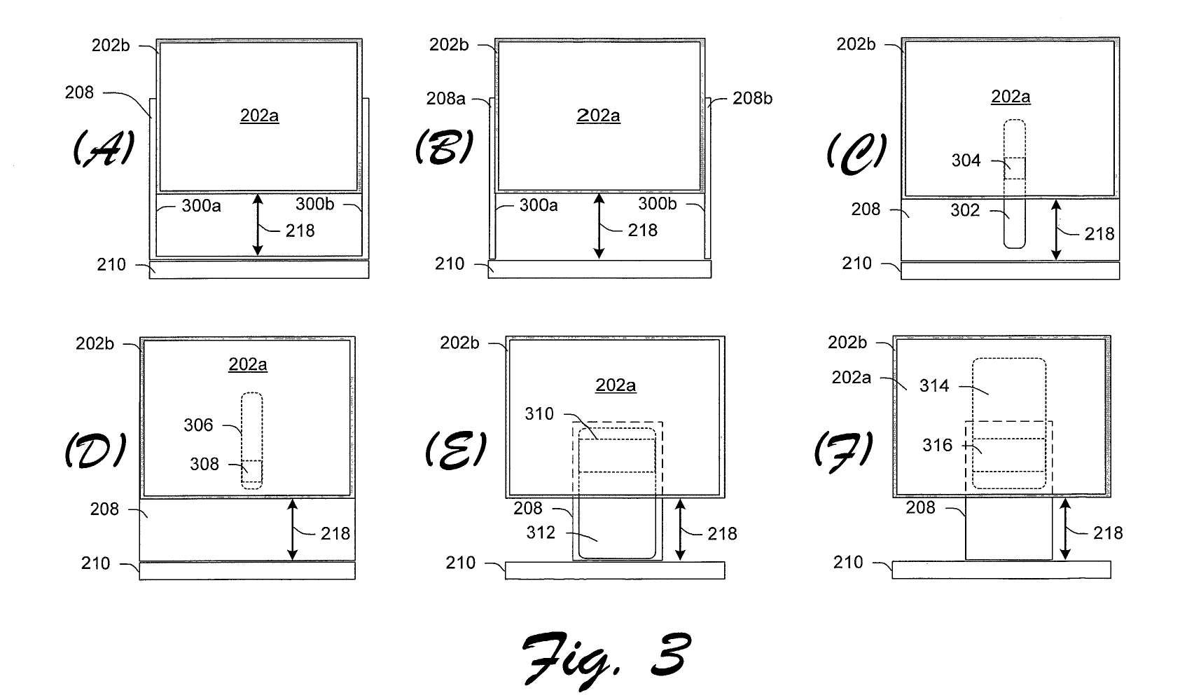

With this in mind, FIG. 2 depicts a side view of an exemplary bi-folding portable computer 200 having a screen 202 that can be height adjusted using a height adjusting mechanism 204 (represented by a dashed line region), in accordance with certain implementations of the present invention.

As illustrated in FIG. 2, the display unit 206 of portable computer 200 includes a support unit 208 and screen 202. Support unit 208 is pivotally connected to a base unit 210 having a keyboard 212. By way of example, support unit 208 and base unit 210 may be pivotally connected together using one or more hinges 214. These and other types of pivoting arrangements are well known.

Screen 202 is movably coupled to support unit 208 with height adjusting mechanism 204 that is configured to allow the user to adjust the height of screen 202 with respect to base unit 210. In this example, as indicated by arrow 218, screen 202 is configured to be height adjusted about parallel to support unit 208 as height adjusting mechanism 204 allows screen 202 to slide up and down. As a result, the distance 220, for example, between the plane of base unit 210 and the center of screen 202 can be adjusted by the user to provide a more ergonomic and/or comfortable position between the user's body and the keyboard 212 and screen 202.

Height adjusting mechanism 204 may include, for example, one or more guides, groves, tracks, slots, rails, or the like, within either support unit 208 that interface with opposing features of screen 202. Similarly, for example, one or more guides, groves, tracks, slots, rails, and/or the like, may be provided within screen 202 that interface with opposing features of support unit 208. As a result of such mechanical interfaces, screen 202 can be slidably adjusted upward and downward, parallel or about parallel with support unit 208.

The user can open portable computer 200 by pivoting display unit 206 away from base unit 210. In certain implementations, the user may first need to unlock a locking mechanism 222 that holds display unit 206 and base unit 210 together when closed. Once opened up to a desired angle 224, the user may then adjust the height of screen 202.

To maintain the adjusted height of screen 202, height adjusting mechanism 204 may include a height locking feature 226 (also represented by a dashed line region). In certain implementations, for example, height locking feature 226 may be configured to interact with locking mechanism 222 to hold screen 202 in a height adjusted position. In other implementations, height locking feature 226 may employ a ratcheting, detention, or other like technique to establish and/or maintain the adjusted height of screen 202. In still other implementations, height locking feature 226 may employ friction based techniques to hold screen 202 at various adjusted heights. In still other exemplary implementations, height locking feature 226 may utilize a sliding tab, screw, or other like mechanical engaging techniques that the user to lock/unlock screen 202 at certain heights.

In certain more complex implementations, height adjusting mechanism 204 may employ electrically controlled movement techniques to adjust and/or maintain the height of screen 202. For example, an electrical motor and/or like device(s) (not shown) may be included and arranged in height adjusting mechanism 204, screen 202, support unit 208, and/or base unit 210. Here, for example, the user could then control the movement screen 202 through a user interface. The user interface (not shown) may include a switch (e.g., up/down) that is arranged in one of the units of portable computer 200.

In other implementations, software programs may be provided to operate within portable computer 200 and allow the user to selectively adjust the height of screen 202. Indeed, by using an electrically controlled movement the user or users may establish and set certain preferred screen positions that are stored in memory within portable computer 200. With this stored information, the height adjustment may subsequently be automated, such that screen 202 is automatically positioned according to the user(s) preference(s). An electrically controlled movement may also be configured to automatically retract to a position that allows portable computer 200 to be closed by the user.

Display unit 206 may take on several different configurations. Some examples are depicted in FIG. 3A-F, in accordance with certain further implementations of the present invention. Here, support unit 208 and display screen 202 are shown in various configurations without illustratively showing height adjusting mechanism 204 since it is assumed that height adjusting mechanism 204 is visually hidden, at least in these illustrations, within support unit 208, screen 202 and/or base unit 210. In these examples, display screen 202 includes a screen 202a and a screen frame 202b.

In FIG. 3A, screen frame 202b is configured to slide up and down using features 300a-b provided by support unit 208. Features 300a-b may include, for example, grooves, channels, tracks, etc. Similarly, in FIG. 3b, screen frame 202b is configured to slide up and down within features 300a-b provided by support unit 208, which has two parts 208a and 208b.

In FIG. 3C, support unit 208 includes a feature 302 that is engaged by a corresponding feature 304 of screen frame 202b such that the height 218 can be changed by feature 304 moving up and down along feature 302. Similarly, in FIG. 3D, support unit 208 includes a feature 308 that is engaged by a corresponding feature 306 of screen frame 202b such that a height 218 can be changed by feature 306 moving up and down along feature 308.

FIG. 3E and FIG. 3F show other exemplary arrangements, wherein support unit 208 is narrower in width than display screen 202. For example, in FIG. 3E, support unit 208 includes a feature 312 that is engaged by a corresponding feature 310 of screen frame 202b such that a height 218 can be changed by feature 310 moving up and down along feature 312. Similarly, as shown in FIG. 3F, support unit 208 may include a feature 316 that is engaged by a corresponding feature 314 of screen frame 202b such that a height 218 can be changed by feature 314 moving up and down along feature 316.

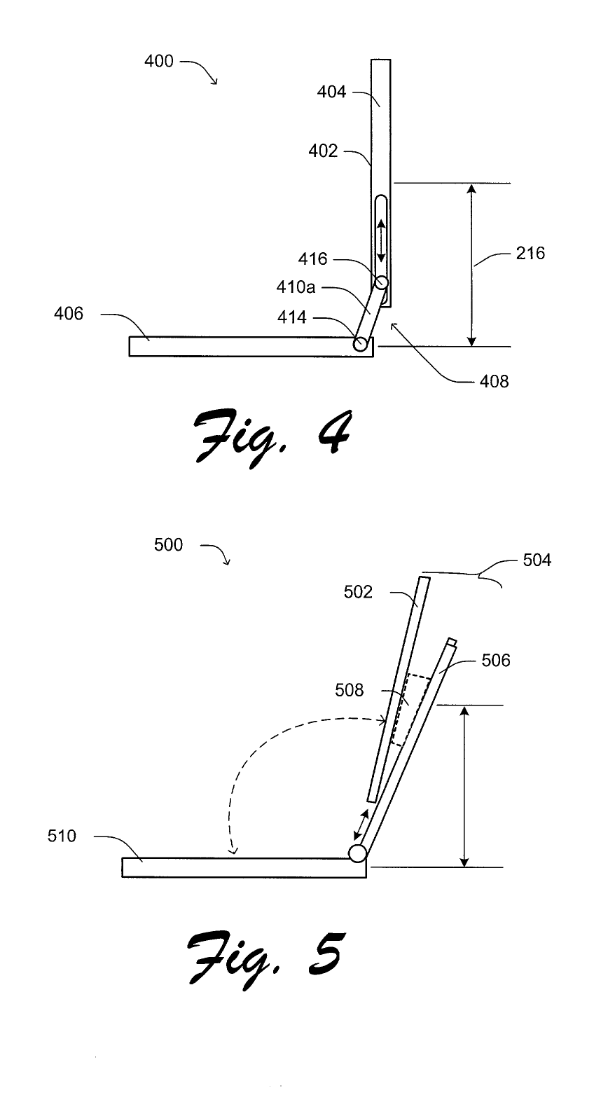

FIG. 4 depicts another exemplary bi-folding portable computer 400 having a screen 402 that can be height adjusted using a multi-pivoting mechanism 408, in accordance with certain other implementations of the present invention. Here, display unit 404, which includes screen 402, is mechanically coupled to base unit 406 with a multi-pivoting mechanism 408. Multi-pivoting mechanism 408, in this example, includes two extension arms 410a-b (note only 410a is visible in this side view) that each have a proximate end 414 that is pivotally coupled to base unit 406, and a distal end 416 that is pivotally coupled to display unit 404. The extension arms 410a-b allow display unit 404 to be raised to different heights 216, with respect to base unit 406.

In this exemplary implementation, the distal end 416 is also configured to slidably engage display unit 404, thereby essentially allowing screen 402 to be further height adjusted with respect to base unit 406, and to properly fold up when the portable computer is closed. In other implementations (not shown), the pivoting proximate end 414 may be configured to slidably engage base unit 406 so as to allow for proper closing and possibly lateral positioning of the display unit with respect to base unit 406. In still other exemplary implementations, display unit 404 may include a support unit (not shown) that, as described on the earlier examples above, is configured to allow screen 402 to be further height adjusted with respect to base unit 406.

Although display unit 404 is depicted in FIG. 4 as being perpendicular to base unit 406, it should be understood that display unit 406 can be positioned at other angles given the various pivotal mechanisms.

Reference is now made to FIG. 5, which depicts yet another exemplary bi-folding portable computer 500 having a screen 502 that can be height adjusted and pivotally/rotationally adjusted, in accordance with still other implementations of the present invention.

Here, a display unit 504 includes screen 502, support unit 506, and a pivot and/or rotation movement mechanism 508. As in the previous examples, support unit 506 is operatively engaged with screen 502 and base unit 510 such that screen 502 can be height adjusted in some manner with respect to base unit 510. In addition to being able to adjust the height of screen 502, the user may further adjust the angle 512 of screen 502 with respect to the plane of base unit 510 by using movement mechanism 508. Thus, for example, the user may selectively tilt screen 502 to a preferred position. As in the previous examples, such positioning may be accomplished manually and/or electrically.

In accordance with still further implementations of the present invention, movement mechanism 508 may be configured to rotate screen 502 ninety degrees, such that a rectangular screen can be placed in a vertical or portrait position as opposed to the normal horizontal or landscape position. The vertical position may be advantageous since it may allow for a full page of text to be displayed. Of course, the hardware and software (e.g., display driver) in portable computer 500 would need to be able to identify the position of screen 502 and make any necessary image corrections.

In accordance with still other implementations of the present invention, the screens and support units in the above various configurations may also be configured to adjust the height of the screen with respect to the base unit by having either the screen and/or the support unit employ a telescoping-like mechanism.

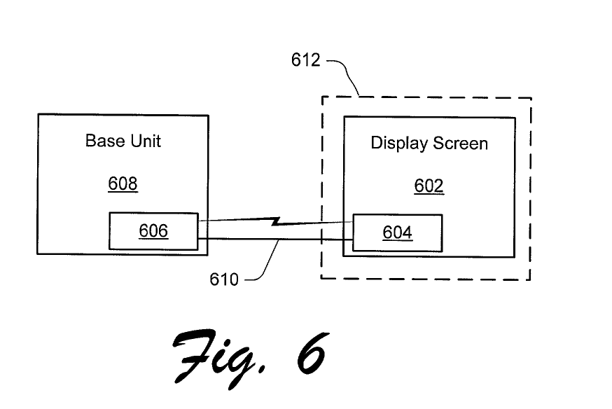

FIG. 6 is a block diagram depicting exemplary techniques for operatively coupling a height adjustable and/or pivotally/rotationally adjustable screen to a base unit, in accordance with certain implementations of the present invention. Here, screen 602 includes an interface 604 that is operatively coupled to a corresponding interface 606 that is part of base unit 608. Information to be displayed on screen 602 is provided through interfaces 606 and 604.

In certain exemplary implementations, interfaces 606 and 604 are electrically coupled via one or more conductors 610. This means, for example, that in certain configurations conductors 610 need to extend through the support unit 612 that mechanically interfaces with screen 602 and base unit 608. Hence, conductors 610 need to be long enough to support the full range of height adjustments of screen 602.

In certain other exemplary implementations, interfaces 606 and 604 may include wireless communication interfaces such that fewer conductors are required to operatively couple screen 602 and base unit 608 together. By way of example, interfaces 606 and 604 may employ infrared-based communication to carry data that is to be displayed.

Given the various exemplary implementations described above and others, those skilled in the art will clearly recognize that a user can selectively position a display screen at a variety of heights and/or angles. In certain implementations the number of positions/angles may be finite, while in other implementations, the number of positions/angles may essentially be infinite, within an applicable range.

Thus, although some preferred implementations of the various apparatuses of the present invention have been illustrated in the accompanying Drawings and described in the foregoing Detailed Description, it will be understood that the invention is not limited to the exemplary implementations disclosed, but is capable of numerous rearrangements, modifications and substitutions without departing from the spirit of the invention as set forth and defined by the following claims.

What is claimed is:

1. A portable computing device comprising:
a base unit; and
a display unit pivotally coupled to the base unit and having a height adjustable screen.

2. The portable computing device as recited in claim 1, wherein the display unit further includes a support unit that is pivotally coupled to the base unit and a position adjusting mechanism coupling the height adjustable screen with the support unit.

3. The portable computing device as recited in claim A2, wherein the position adjusting mechanism is configured to allow the height adjustable screen to be positioned at least two different height distances from the base unit.

4. The portable computing device as recited in claim 3, wherein the position adjusting mechanism is configured to allow the height adjustable screen to be manually moved with respect to the support unit between the two different height distances.

5. The portable computing device as recited in claim 3, wherein the position adjusting mechanism is configured to allow the height adjustable screen to be electrically moved with respect to the support unit between the two different height distances.

6. The portable computing device as recited in claim 3, wherein the position adjusting mechanism is configured to allow the height adjustable screen to be slidably moved with respect to the support unit between the two different height distances.

7. The portable computing device as recited in claim 3, wherein the support unit includes a height locking feature configured to hold the height adjustable screen at, at least one of the two different height distances.

8. The portable computing device as recited in claim 2, wherein the support unit includes at least one arm pivotally coupled to the base unit and pivotally coupled to the height adjustable screen.

9. The portable computing device as recited in claim 1, wherein the height adjustable screen includes an interface configurable receive information from a corresponding interface in the base unit.

10. The portable computing device as recited in claim 1, wherein the base unit includes at least one user input device.

11. A n apparatus suitable for use in a portable computing device, the apparatus comprising:
a support unit configurable to be pivotally coupled to a base unit and having at least one position adjusting feature; and
a display screen having at least one corresponding position adjusting feature that is operatively coupled to the position adjusting feature of the support unit and configured to allow the position of the display screen to be changed with respect to the support unit.

12. The apparatus as recited in claim 11, wherein the position adjusting features are operatively coupled together such that a height of the display screen can be changed.

13. The apparatus as recited in claim 11, wherein the position adjusting features are operatively coupled together such that a viewing angle of the display screen can be changed.

14. The apparatus as recited in claim 11, wherein the position adjusting features are operatively coupled together such that a rotational angle of the display screen can be changed.

15. An apparatus suitable for use in a portable computing device having a base unit, a support unit and a display screen, the apparatus comprising:
a first height adjusting feature configurable to be fixedly coupled to a support unit; and
a second height adjusting feature movably coupled to the first height adjusting feature and configurable to be fixedly coupled to a display screen such that the display screen can be moved with respect to the support unit and have a resulting position of the display screen maintained.
